(19) United States
(12) Patent Application Publication
(10) Pub. No.: US 2010/0123926 A1
(43) Pub. Date: May 20, 2010

(54) IMAGE FORMING APPARATUS AND CONTROL METHOD THEREOF

(75) Inventor: Hideyuki Kitani, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/603,042

(22) Filed: Oct. 21, 2009

(30) Foreign Application Priority Data
Nov. 17, 2008 (JP) 2008-293937

(51) Int. Cl. G06F 15/00

(52) U.S. Cl. 358/1.15

(57) ABSTRACT

The image forming apparatus determines the type of page description language or file format of received print data even if the image forming apparatus is not capable of handling the type of page description language or file format of the received print data. According to the determined result, the image forming apparatus performs control to process the print data or not to process the print data.

### BACKGROUND OF THE INVENTION

1. Field of the Invention

The present invention relates to an image forming apparatus which processes received print data and a control method thereof.

2. Description of the Related Art

Conventionally, page description language (PDL) data is used for print data that is transmitted to an image forming apparatus, such as a multi-function peripheral or a printing device. Examples of a PDL include PostScript (registered trademark), PCL (registered trademark), LIPS (registered trademark), and ESC/P (registered trademark). PDL data is generated by application software running on a host computer, and is transmitted to an image forming apparatus through a network. In a situation where only the same kind of computer or application software is used, an image forming apparatus need support only one PDL in order to process the print data in a preset PDL mode.

However, in a situation where a plurality of types of computers and application software are used, the image forming apparatus must be able to process a plurality of types of PDL data. In such a case, it is necessary to determine the PDL type of the received print data and to perform data processing of the PDL in accordance with the determination result.

Consequently, numerous techniques have been proposed to determine which PDL is used in the received print data among the PDLs that the image forming apparatus is capable of handling. There are techniques disclosed which inform an external device if the PDL used in the received print data is none of the PDLs that the image forming apparatus is capable of handling (for example, refer to Japanese Patent Laid-Open No. 4-37930).

Moreover, the PDL data transmitted is print data which application software generates for printing, and therefore, after newly installing an image forming apparatus, the new image forming apparatus must be capable of handling the PDLs generated by the application software. On the other hand, after installing new application software, the application software must be capable of generating PDL data which an already installed image forming apparatus is capable of handling, and if not, a need arises to replace the image forming apparatus with an image forming apparatus which supports the PDL generated by the newly installed application software.

Accordingly, in cases where application software is used for printing, there is a need to guarantee conformity with the image forming apparatus during operation. In U.S., European and Japanese markets, many of the necessary PDLs are capable of handling the image forming apparatus as a standard configuration or as an optional configuration, and therefore, conformity of application software and the image forming apparatus is generally not a problem.

Therefore, in a conventional image forming apparatus, a determination is made as to which PDL is being used in the received print data, and if none of the supported PDLs correspond to the print data, the apparatus performs error processing such as external reporting of the issue.

As described above, the image forming apparatus not being capable of handling the PDL generated by the application software is an uncommon problem.

However, in recent years application software has come to generate print data in formats other than PDL data, such as PDF, JPEG, HTML, PPML, and XPS and directly transmit these to the image forming apparatus. The important difference between these files and general PDLs is that the user handles the files himself/herself.

The user generates, edits, and saves these files with application software or a digital camera himself/herself (not directly related to printing), and provides the files to other users.

Moreover, file formats are created frequently, as needed, and if some users begin to use a given file format, it may spread widely within a short period of time via mediums such as the Internet.

Depending upon the cost allowed for the image forming apparatus and on the time at which the new file format becomes popular, there may be cases where the image forming apparatus is not able to support all the new file formats.

The problem here arises when the user has mistakenly transmitted data to the image forming apparatus in a file format which it cannot handle. When transmitting a file to an image forming apparatus without modification, the user must first determine whether or not the image forming apparatus supports the given file format.

Furthermore, if there is a plurality of image forming apparatuses available to the user, it is necessary to recognize the file format supported by each of the image forming apparatuses.

In such situations, it is necessary to consider cases where the user mistakenly transmits data to an image forming apparatus in a file format which it is not capable of handling, and it is necessary to avoid the inconveniences that arise from doing so to the extent possible.

Consequently, in this case, printing cannot be performed properly. However, the user can obtain proper printing results by retransmitting to a suitable image forming apparatus, and therefore, it is not a major problem if the error does not occur frequently.

However, a major problem does exist when the user has mistakenly transmitted data to an image forming apparatus in a file format which it is not capable of handling and the data is processed as another PDL or another file format which the image forming apparatus is capable of handling, and thus, much useless paper is printed out. In this case, consumable supplies, such as paper and toner/ink, and electric power are wasted, and since the image forming apparatus is occupied for a long time, it becomes troublesome to other users as well.

### SUMMARY OF THE INVENTION

The present invention provides an apparatus and a method which determine whether the received print data can be processed or not, and performs control so as to not process the print data if the print data format is not supported.

According to one aspect of the present invention, there is provided an image forming apparatus comprising: a determination unit that determines a type of page description language or file format of received print data even if the image forming apparatus is not capable of handling the type of page description language or file format of the received print data; and a control unit that performs control to process the print data or not process the print data in accordance with the result determined in the determination unit.

According to another aspect of the present invention, there is provided a method of controlling an image forming apparatus comprising: determining the type of page description language or file format of received print data even if the image forming apparatus is not capable of handling the type of page description language or file format of the received print data; and performing control to process the print data or not to process the print data according to the result determined in the determining step.

Further features of the present invention will become apparent from the following description of exemplary embodiments (with reference to the attached drawings).

### BRIEF DESCRIPTION OF THE DRAWINGS

FIG. 1 depicts an example of a hardware arrangement of a 1D color multi-function peripheral 100 according to the present embodiment.

FIG. 2 depicts a block diagram showing an example of an arrangement of a control unit (controller) in the color multi-function peripheral 100.

FIG. 3 depicts a figure showing an example of an arrangement of the image forming system according to the present embodiment.

FIG. 4 depicts a block diagram showing an arrangement of software which controls operation of the MFP.

FIG. 5 depicts a block diagram showing details of a PDL determination unit and a PDL analysis unit according to the present embodiment.

FIGS. 6A and 6B depict a flow chart which shows print data processing based on the result of the PDL determination and analysis according to the present embodiment.

FIG. 7 depicts an example of the user interface according to the present embodiment.

### DESCRIPTION OF THE EMBODIMENTS

Hereinafter, a preferred embodiment of the invention will be described in detail with reference to the drawings.

<Arrangement of the Image Forming Apparatus>

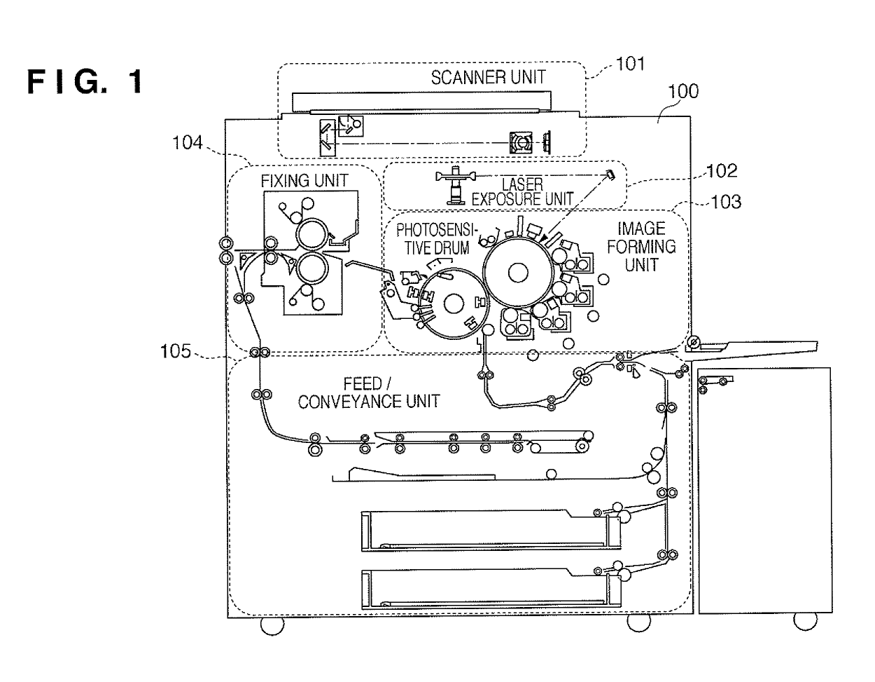

First, a hardware arrangement of a 1D color multi-function peripheral will be described with reference to FIG. 1. It is noted that the present invention is not limited to a color multi-function peripheral, and may be applied to other image forming apparatus, such as monochrome multi-function peripherals, single function printer devices, and the like.

FIG. 1 depicts an example of a hardware arrangement of a 1D color multi-function peripheral 100 according to the present embodiment. The 1D color multi-function peripheral (hereafter also referred to as a “multi-function peripheral”) 100 is comprised of a scanner unit 101, a laser exposure unit 102, an image forming unit 103, a fixing unit 104, and a feed/conveyance unit 105. These are controlled by a printer control unit (not illustrated).

The scanner unit 101 lights a document placed on a platen, reads a document image optically, converts the image into an electrical signal, and creates image data. The laser exposure unit 102 enters ray of light, such as a laser light, which is modulated according to the image data into a rotating polygon mirror which rotates at a constant angular rate, and irradiates the light onto a photosensitive drum as a reflected scanning light.

The image forming unit 103 rotates the photosensitive drum, electrifies it with an electrifier, and develops a latent image formed on the photosensitive drum with toners using the laser exposure unit 102. Thereafter, the toner image is transferred onto a sheet, and any minute toner which remains on the photosensitive drum without being transferred onto the sheet are collected. When performing a series of these electrophotography processes for creating an image, the development units (development stations) repeatedly perform the electrophotography processes sequentially while a sheet winds around at a predetermined position in the transfer belt and rotates four times. The development unit has magenta (M), cyan (C), yellow (Y), and black (K) toners. After the four rotations, the sheet on which a full four color toner image is transferred leaves the transfer drum, and is conveyed to the fixing unit 104.

The fixing unit 104 is comprised of a combination of rollers and belts, has heat sources, such as a halogen heater built in, and melts and fixes the toner on the sheet onto which a toner image is transferred by the image forming unit 103 with heat and pressure.

The feed/conveyance unit 105 has a sheet storage of one or more sheets, such as a sheet cassette and a paper deck, and separates one sheet out of the plurality of sheets stored in the sheet storage according to instructions from the printer control unit, and conveys it to the image forming unit 103 and the fixing unit 104. The sheet winds around the transfer drum of the image forming unit 103, and after the sheet rotates four times, it is conveyed to the fixing unit 104. While rotating four times, the toner images for each of the above-described YMCK colors are transferred onto the sheet. In a case where the image is to be formed onto both sides of the sheet, the sheet which passed the fixing unit 104 is controlled so as to route a double-sided conveyance path which conveys the sheet to the image forming unit 103 again.

The printer control unit communicates with a control unit which controls the overall multi-function peripheral 100, and performs control according to the directions of the control unit. Moreover, the printer control unit performs control such that the overall system operates properly and smoothly by managing the operation of each of the scanner unit 101, the laser exposure unit 102, the image forming unit 103, the fixing unit 104, and the feed/conveyance unit 105.

<Arrangement of the Control Unit>

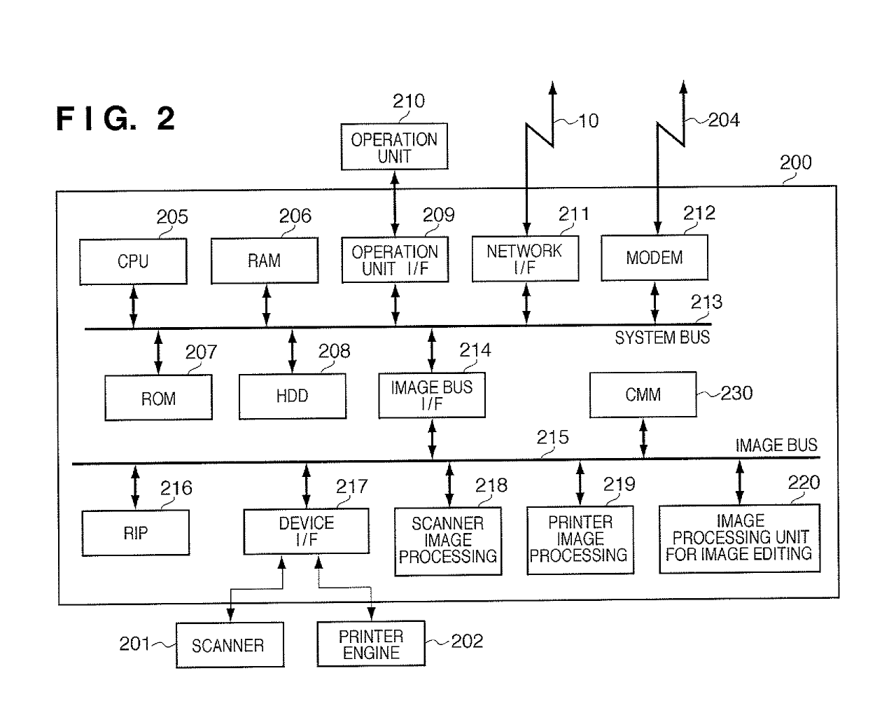

FIG. 2 depicts a block diagram showing an example of an arrangement of a control unit (controller) in the color multi-function peripheral 100. The control unit 200 connects with a scanner 201 which is an image input device and a printer engine 202 which is an image output device to perform a control for reading data and for printing out. Moreover, the control unit 200 is also a unit for inputting and outputting image information and device information via a network by connecting with a LAN 10 or a public line 204.

In the control unit 200, a CPU 205 is a central processing unit for controlling the overall system. A RAM 206 is a system work memory for the operation of the CPU 205, and is also an image memory for storing the input image data temporarily. A ROM 207 is a boot ROM and stores a boot program of the system. An HDD 208 is a hard disk drive and stores system software for various processing, input image data, document data, which will be described later, etc.

An operation unit I/F 209 is an interface to an operation unit 210 which has a display screen capable of displaying image data, etc., and outputs image data to the operation unit 210. Moreover, the operation unit I/F 209 gives information which the operator (i.e., user of the color multi-function peripheral) input to the operation unit 210, to the CPU 205. Furthermore, a network I/F 211 is implemented as, for example, a LAN card, and performs input and output of information with external devices by connecting to the LAN 10. Moreover, a modem 212 performs input and output of information with external devices by connecting with a public telephone line 204.

The above devices are arranged on a system bus 213 of the control unit 200.

Next, an image bus I/F 214 is an interface which connects the system bus 213 and an image bus 215, which will be described later, and is a bus bridge which converts data structures. The image bus 215 is a bus for transferring image data at high speed, and is a PCI or IEEE 1394 bus. Connected to the image bus 215 are devices such as an RIP 216, which will be described later, a device I/F 217, a scanner image processing device 218, a printer image processing device 219, an image processing unit for image editing 220, and a CMM 230.

The RIP (raster image processor) 216 expands page description language (PDL) codes and vector data, which will be described later, into an image. The device I/F 217 connects the scanner 201 and the printer engine 202, to the control unit 200, and converts image data between synchronous systems and asynchronous systems.

Moreover, the scanner image processing device 218 performs to the input image data various processing, such as compensation, processing, and editing. The printer image processing device 219 performs processing, such as compensation and resolution conversion, on the image data to be printed out. The image processing unit for image editing 220 performs rotation of image data and compression and expansion processing of image data, and various image processing based on attribute bits which the RIP 216 generates. The CMM (color management module) 230 is a dedicated hardware module which applies color conversion processing to the image data based on a profile and calibration data.

Here, a profile is information such as a function for converting color image data expressed with a device-dependent color space into a device-independent color space (for example, Lab). The calibration data is data for correcting color reproduction characteristics of the scanner 201 and the printer engine 202.

<System Configuration>

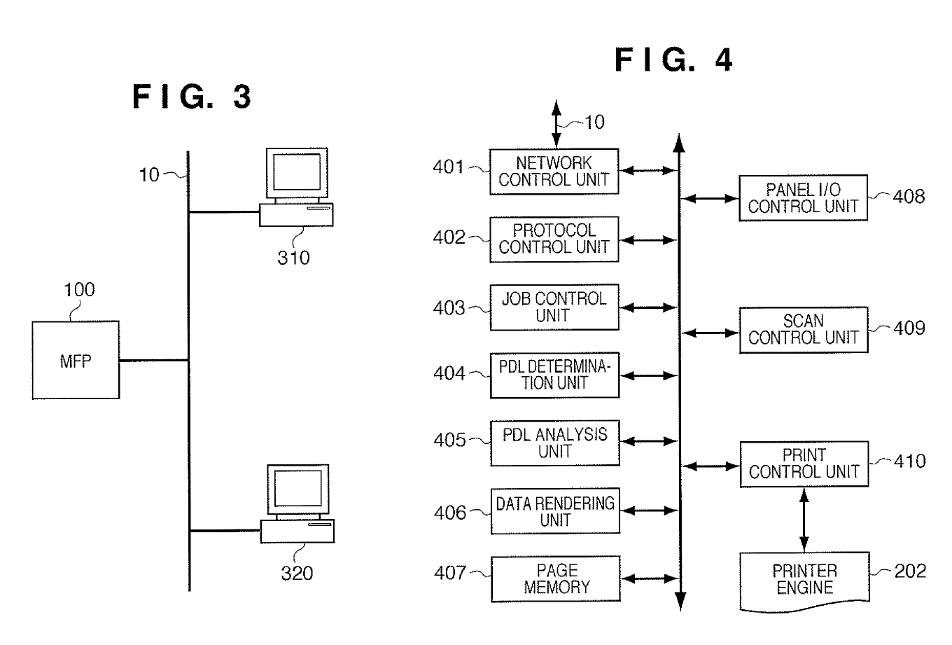

FIG. 3 depicts a figure showing an example of an arrangement of the image forming system according to the present embodiment. In the example shown in FIG. 3, the 1D color multi-function peripheral (MFP) 100 which has a function to determine the kind of PDL and file format is connected to computers 310 and 320 on the network 10, such as a LAN.

It should be noted that there may be an arbitrary number of MFPs 100 and computers 310 and 320, connected to the network 10. Moreover, the connection between MFP 100 and the computers 310 and 320 is not limited to this configuration, and they may be connected, for example, via the Internet, a telephone line, or a local connection such as USB.

<Controller Software Configuration>

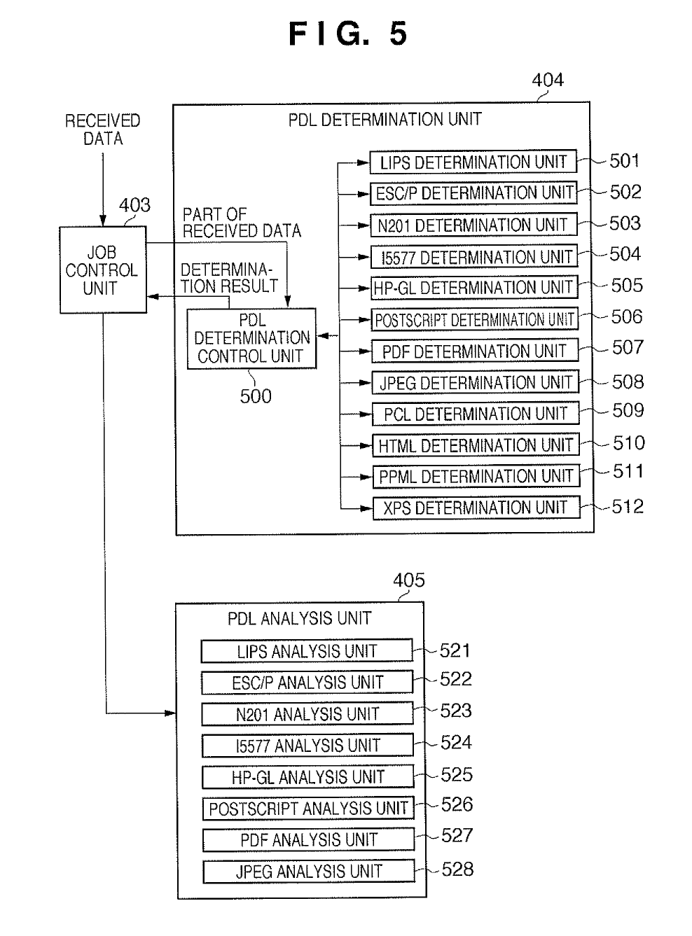

FIG. 4 depicts a block diagram showing an arrangement of software that controls operation of the MFP. A network control unit 401 controls transmission and reception of data with the network 10. A protocol control unit 402 analyzes the protocol between the computers 310, 320, and controls communication with the computers 310, 320 through the network control unit 401.

For example, a job control unit 403 performs start processing of a PDL determination unit 404 and a PDL analysis unit 405 in response to the print job received from the computers 310 and 320.

The PDL determination unit 404 analyzes the print job according to instructions from the job control unit 403, and determines the type of PDL or file format. In response to the instructions from the job control unit 403, the PDL analysis unit 405 analyzes electronic document data in PDL, PDF, JPEG, or like format received as a print job, and generates vector data. Furthermore, the vector data is converted into an intermediate code which is in a form suitable for print processing to pass on to a data rendering unit (renderer) 406.

The data rendering unit 406 expands the intermediate code to raster data, and sequentially writes the expanded raster data to a page memory 407. The page memory 407 is a volatile memory which holds primarily raster data expanded by the data rendering unit 406.

A panel I/O control unit 408 controls input/output with the operation unit 210. A scan control unit 409 performs various processing, such as compensation processing and editing, on the image data input from the scanner 201. A printing control unit 410 converts the content in the page memory 407 into a video signal, and performs image transfer to the printer engine 202. The printer engine 202 is a mechanical printing device for forming a permanent visible image onto a sheet of recording paper from the received video signal.

<Structure of PDL Determination Unit/PDL Analysis Unit>

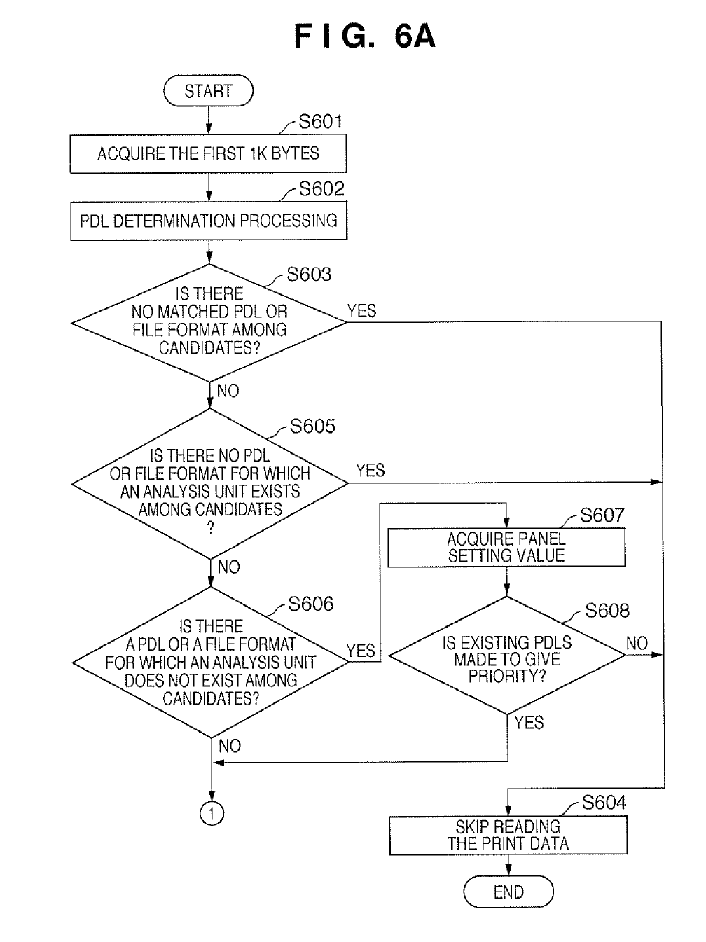

FIG. 5 depicts a block diagram showing details of a PDL determination unit and a PDL analysis unit according to the present embodiment. After the job control unit 403 receives the received data, the first 1K bytes of the received data is passed to the PDL determination control unit 500 to support the determination of the type of PDL or file format.

After receiving data for the determination, the PDL determination control unit 500 transfers data to the determination units 501-512 which determine the type of PDL or the file format in the PDL determination unit 404. The determination units 501-512 analyze the received data, check command syntax for each unit and the like, determine how much data is in agreement with the corresponding PDL or file format, and returns the determination result to the PDL determination control unit 500. Here, the determination result has four levels of values, 0-3, with 3 being the highest. This value is referred to as the “accuracy of the determination result”, or simply, the “accuracy.”

It is noted that although the determination unit included in the PDL determination unit 404 determines the following twelve PDLs and file formats, in an example shown in FIG. 5, the present invention is not limited to this.

LIPS, ESC/P, N201, I5577, HP-GL (registered trademark), PostScript, PDF, JPEG, PCL, HTML, PPML, and XPS

Based on the determination result of the determination units 501-512, the PDL determination control unit 500 returns the type of PDL or file format that has the highest accuracy value to the job control unit 403.

It is noted that if all of the replies from the determination units 501-512 are “0”, the PDL determination control unit 500 returns information to the job control unit 403 indicating that an “applicable PDL or file format does not exist”.

Moreover, based on the determination result of the PDL determination unit 404, the job control unit 403 starts any one of the analysis units 521-528 which analyzes the PDL and the file format in the PDL analysis unit 405.

It is noted that if the determination result of the PDL determination unit 404 is a PDL or a file format for which there is no analysis unit, such as PCL, PPML, and XPS, the job control unit 403 skips the print data, without starting the PDL analysis unit 405.

Moreover, if information indicating that an “applicable PDL or file format does not exist” is received from the determination result of the PDL determination unit 404, that is, from the PDL determination control unit 500, the job control unit 403 skips data printing, without starting the PDL analysis unit 405.

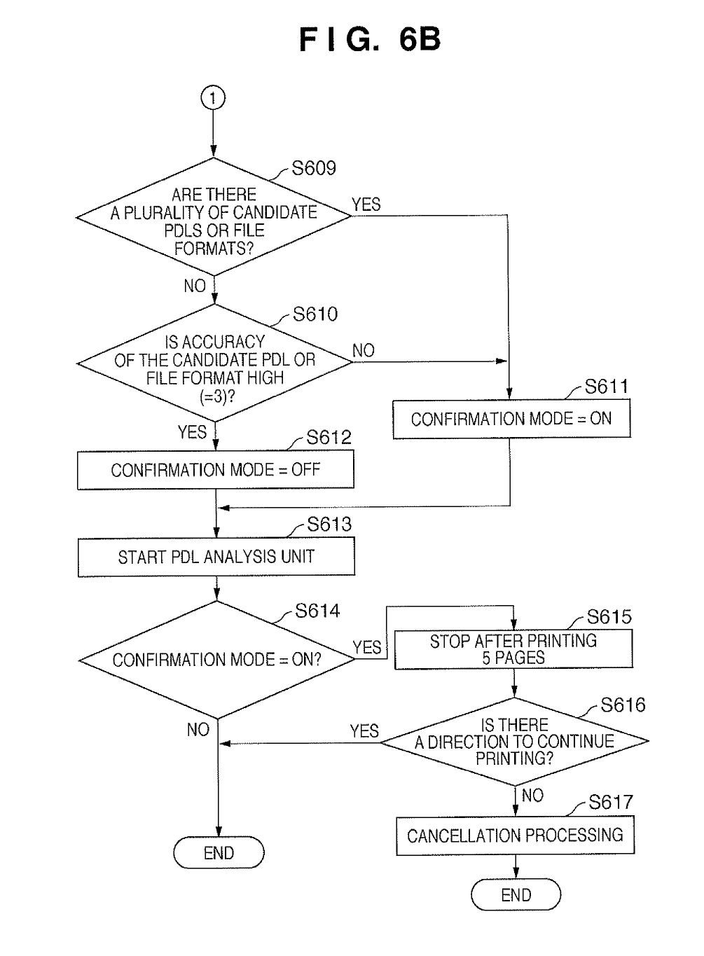

Now, processing for the cases where a plurality of PDLs or file formats with comparable determination result accuracy exist, and for the cases where the accuracy of the determination result is low and there remains ambiguity will be described with reference to FIGS. 6A and 6B.

FIGS. 6A and 6B depict a flow chart which shows print data processing based on the result of the PDL determination and analysis according to the present embodiment. The process starts after data received from the network control unit 401 is passed to the job control unit 403.

First, in Step S601, the job control unit 403 retrieves the first 1K bytes. In Step S602, PDL determination processing is performed. The PDL determination processing is processing which the PDL determination control unit 500 of the PDL determination unit 404 passes data to each of the determination units 501-512 to collect the determination results, and determines a PDL or a file format which has a highest accuracy value.

After the PDL determination processing is completed, the process proceeds to Step S603 and the existence of the matched PDL or file format is checked. If it is determined that a matched PDL or file format does not exist, that is, if it is determined that all of the determination units 501-512 have the accuracy “0”, the process proceeds to Step S604 and skips the print data, and ends the processing.

Moreover, if at least one matched PDL or file format exists, the process proceeds to Step S605, and checks whether the analysis unit of the PDL or file format exists or not. As a result, if the analysis unit of the PDL or file format does not exist, that is, if the PDL or file format corresponds to neither of the analysis units 521-528, the process proceeds to Step S604, and skips reading the print data, and ends the processing.

On the other hand, if a candidate corresponding to any of the analysis units 521-528 is included, the process proceeds to Step S606, and it is checked whether or not candidates other than the analysis units 521-528 are included. As a result, if candidates other than the analysis units 521-528 are included, that is, if both the analysis units 521-528 and others are included, the process proceeds to Step S607, and the user determines which to give the priority to.

Here, the user specifies whether or not to give priority on the analysis of the capable PDL or file format from an operation panel of the operation unit 210. In Step S608, it is determined which to give the priority to by acquiring the panel setting value specified by the user.

In this Step S608, if it is determined that “priority is given to capable PDLs”, the process proceeds to Step S609. Moreover, if it is not determined that “priority is given to capable PDLs”, the process proceeds to Step S604, reading the print data is skipped, and processing ends.

Next, in Steps S609 and S610, it is determined whether ambiguity exists. First, in Step S609, it is determined whether or not a plurality of PDLs or file formats which serve as candidates exist. If more than one exists, that is, if ambiguity remains, the process proceeds to Step S611. Moreover, if only one PDL or file format which serves as a candidate exists, the process proceeds to Step S610, and it is determined whether or not the accuracy of the PDL or file format which serves as a candidate is the highest (accuracy 3). As a result of the determination, if it is not the highest, that is, if ambiguity remains, the process proceeds to Step S611.

In this Step S611, since ambiguity remains in the PDL determination for the print data which should be processed, “confirmation mode” is turned ON to perform processing thereafter. On the other hand, if it is determined that there is no ambiguity at the above-described Steps S609 and S610, the process proceeds to Step S612 to set “confirmation mode” OFF and to perform the processing thereafter.

The “confirmation mode” is information stored in a predetermined region in the RAM 206, and controls with the ON/OFF information, whether or not to set timing for the user to confirm whether to continue printing.

Whether the “confirmation mode” is set ON or OFF in the above Step S611 or S612, the process proceeds to Step S613. In Step S613, the PDL analysis unit 405 is started to begin the analysis. The analysis unit started here is one of the analysis units 521-528, and which analysis unit is started depends on the determination result of the PDL determination unit 404.

It should be noted that if a plurality of PDLs or file formats exist as candidates, the analysis unit to be started is determined according to the priority.

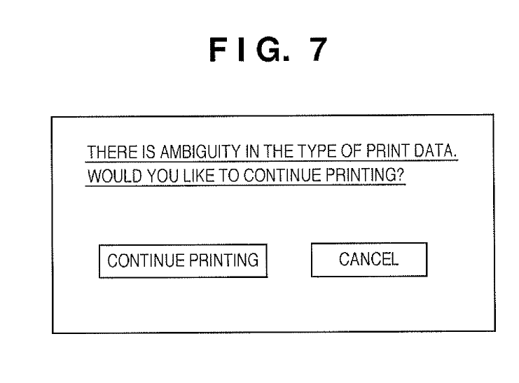

The printing is started with the analysis and the check for the “confirmation mode” is done in Step S614. Here, if the “confirmation mode” is OFF, all pages are printed and the processing ends. However, if the “confirmation mode” is ON, the process proceeds to Step S615 to display a message as shown in FIG. 7 in the operation unit 210 after printing 5 pages.

Next, in Step S616, it is determined which of “CONTINUE PRINTING” and “CANCEL” buttons (FIG. 7) is chosen, and if “CONTINUE PRINTING” is selected, printing is resumed to print all pages, and processing is ended. If “CANCEL” is selected, the processing proceeds to Step S617 to perform cancellation processing of printing, and processing is ended.

According to the present embodiment, PDL determination and PDL analysis are performed even on the print data of PDL or file formats which are not supported by the MFP, and therefore, the probability of an incorrect determination is reduced substantially. This is because in the conventional decision processing, if a determination unit for a PDL or a file format which is not supported by the MFP does not exist, there may be a case where ambiguity remains in the determination accuracy, such as 0-2, and the print data is incorrectly determined as printable.

In the present embodiment, a PDL or file format that is not supported by the MFP is generally determined as accuracy 3, and they are given priority in many cases comparing with the incapable PDL or file format.

Moreover, needless printing is avoided by reducing the probability of incorrect determination, and therefore, it is possible to reduce consumption of consumable supplies, such as paper, toner/ink, and electric power.

Furthermore, if it is assumed that ambiguity remains in the determination result, it is possible to deal with an incorrect determination by prompting the user to cancel the job.

<Other Embodiments>

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-293937 filed Nov. 17, 2008, which is hereby incorporated by reference herein in its entirety.

What is claimed is:

1. An image forming apparatus comprising:
a determination unit that determines a type of page description language or file format of received print data even if the image forming apparatus is not capable of handling the type of page description language or file format of the received print data; and
a control unit that performs control to process the print data or not process the print data in accordance with the result determined in the determination unit.

2. The apparatus according to claim 1, wherein the control unit performs control not to process the print data if the image forming apparatus is not capable of handling the type of page description language or file format of the print data.

3. The apparatus according to claim 1, wherein if there is at least one type of page description language or file format which cannot be analyzed by the image forming apparatus in the print data, the determination unit makes a user select whether or not to give priority to the type of page description language or file format that can be analyzed by the image forming apparatus.

4. The apparatus according to claim 3, wherein the control unit performs control so as not to process the print data if the user selected to not give priority in response to the determination unit.

5. The apparatus according to claim 1, wherein if there is at least one type of page description language or file format which cannot be analyzed by the image forming apparatus in the print data, the determination unit makes a user select whether or not to continue processing of the print data.

6. The apparatus according to claim 5, wherein if the user selected to not continue processing the print data in response to the determination unit, the control unit performs control to cancel processing of the print data.

7. A method of controlling an image forming apparatus comprising:
determining the type of page description language or file format of received print data even if the image forming apparatus is not capable of handling the type of page description language or file format of the received print data; and
performing control to process the print data or not to process the print data according to the result determined in the determining step.

8. A program recorded in a computer readable storage medium for causing a computer to execute the method of controlling the image forming apparatus according to claim 7.
